(19) United States
(12) Patent Application Publication
(10) Pub. No.: US 2024/0194175 A1
(43) Pub. Date: Jun. 13, 2024

(54) Mobile Device Assisted Active Noise Control

(71) Applicant: Google LLC, Mountain View, CA (US)

(72) Inventors: Ke Dong, San Jose, CA (US); Wei Wu, Sunnyvale, CA (US); Guohua Sun, Santa Clara, CA (US); Ronald Ho, Fremont, CA (US)

(73) Assignee: Google LLC, Mountain View, CA (US)

(21) Appl. No.: 18/555,181

(22) PCT Filed: Mar. 21, 2022
(86) PCT No.: PCT/US2022/021157

§ 371 Date: Oct. 12, 2023

Related U.S. Application Data
(60) Provisional application No. 63/174,242, filed on Apr. 13, 2021.

(51) Int. Cl. G10K 11/178

(52) U.S. Cl. CPC G10K 11/1783; G10K 2210/30351; G10K 2210/3056

(57) ABSTRACT

The present disclosure provides systems and methods for generating and transmitting, or applying, a noise profile based on a determined environment a host device is operating in. The host device may receive data from one or more sensors, location information, and/or device information. The sensors may include a pressure, temperature, light, location, or humidity sensor. The location information may include data from a global positioning system and/or connectivity signals, such as multicast DNS and/or Bluetooth broadcast. Device information may include schedule data and/or device state information. The data from one or more sensors, the location information, and/or the device information may be aggregated to determine the environment in which the host device is operating in. Based on the determined environment, a noise profile generator may generate a noise profile. The noise profile may define gains to be applied to audio signals being output to the user.

### CROSS REFERENCE TO RELATED APPLICATIONS

The present application claims the benefit of the filing date of U.S. Provisional Application No. 63/174,242, filed Apr. 13, 2021, entitled Mobile Device Assisted Active Noise Control, the disclosure of which is hereby incorporated herein by reference.

### BACKGROUND

Devices may use active noise control (“ANC”) to provide enhanced audio playback. The device may have one or more microphones that pick up, or receive, audio signals from the environment. ANC uses the received environmental audio signals to determine a sound wave to emit in order to compensate for, or otherwise cancel out the environmental audio signals. The emitted sound wave reduces the environmental noise or to make audio play back clearer and/or more intelligible. However, ANC does not account for other enhancements that can be made to audio output based on the environment the device is operating in.

### BRIEF SUMMARY

The present disclosure provides systems and methods for generating, transmitting, and applying a noise profile based on the environment in which a host device is operating in. The host device may detect connectivity signals and/or determine location information regarding a location of the host device. For example, the host device may detect that it is connected to a known WiFi network and/or receive location information from a global positioning system (“GPS”). The connectivity signals and/or location information may be aggregated to create an aggregated location signal. According to some examples, the host device may receive data from one or more sensors, such as sound, pressure, temperature, illuminance, etc. sensors. The host device may, additionally or alternatively, receive device information, such as schedule data and device state. The aggregated location signal may be aggregated with the sensor data and device information to determine the environment in which the host device is operating in. Based on the determined environment, a noise profile may be generated. The noise profile may include one or more gains to be applied to an audio signal. For example, the noise profile may include gains for ANC, hearing assistance control (“HAC”), and/or transparency control (“XPC”). In examples where the host device is outputting the audio signal, the host device may apply the noise profile to the audio signal. In some examples where the host device is wirelessly connected to an accessory and the accessory is outputting the audio signal, the host device may transmit the noise profile to the accessory. The accessory may then apply the noise profile to the audio signal.

One aspect of the disclosure is directed to a host device comprising one or more sensors and one or more processors in communication with the one or more sensors. The one or more processors may be configured to receive data from each of the one or more sensors, determine location information based on location data from one or more location sensors or detected connectivity signals, determine, based on the received data and location information, an operating environment of the host device, receive, from an accessory, audio content including at least one of external audio and playback audio, generate, based on the determined operating environment and the received audio content, a noise profile and transmit, to the accessory, the generated noise profile.

The one or more sensors may include a pressure sensor, a temperature sensor, a light sensor, a location sensor, a presence sensor, and a humidity sensor. The received data from the one or more sensors may include at least one of an air pressure of the environment, an ambient air temperature, a device temperature, an illuminance, and an ambient relative humidity of the environment.

The generated noise profile may include one or more gains to be applied to audio output. The one or more gains may include at least one of hearing assistance control (“HAC”), transparency control (“XPC”), active noise control (“ANC”), total noise cancellation (“TNC”), or passive noise control (“PNC”).

The determined operating environment may include a noise pattern. The host device may further include a communications interface, wherein the host device is wirelessly coupled to the accessory via the communications interface. The detected connectivity signals may be at least one of a multicast DNS within a Wi-Fi network or a Bluetooth broadcast.

Another aspect of the disclosure is directed to a method comprising receiving, from each of one or more sensors, data, determining, by one or more processors based on location data from one or more location sensors or detected connectivity signals, location information; determining, by the one or more processors based on the received data and location information, an operating environment of the host device, receiving, by the one or more processors from an accessory, audio content including at least one of external audio and playback audio, generating, by the one or more processors based on the determined operating environment and the received audio content, a noise profile, and transmitting, by the one or more processors to the accessory, the generated noise profile.

Yet another aspect of the disclosure is directed to a non-transitory computer-readable medium storing instructions, which when executed by one or more processors, cause the one or more processors to receive data from each of the one or more sensors, determine location information based on location data from one or more location sensors or detected connectivity signals, determine, based on the received data and location information, an operating environment of the host device, receive, from an accessory, audio content including at least one of external audio and playback audio, generate, based on the determined operating environment and the received audio content, a noise profile and transmit, to the accessory, the generated noise profile.

### BRIEF DESCRIPTION OF THE DRAWINGS

FIG. 1 is a functional block diagram of an example system in accordance with aspects of the disclosure.

FIG. 2 is a flow diagram illustrating a method of determining the environment in which a device is operating in according to aspects of the disclosure.

FIG. 3 is a graphical representation illustrating an example noise profile according to aspects of the disclosure.

FIG. 4 is a graphical representation illustrating example noise patterns for each stage of an airplane flight according to aspects of the disclosure.

FIG. 5 is a graphical representation illustrating example sound and pressure levels for each stage of an airplane flight according to aspects of the disclosure.

FIG. 6 is a flow diagram illustrating a method of generating a noise profile according to aspects of the disclosure.

### DETAILED DESCRIPTION

The technology relates generally to a host device that determines an environment in which the host device is operating based on any of sensor data, location information, schedule data, etc. The sensor data may include pressure, temperature, light, humidity, or other variables pertaining to the environment the host device is operating in. The location information may be based on global positioning system (“GPS”) data and/or connectivity signals, such as Wi-Fi and Bluetooth. Schedule data may include information derived from the calendar on the host device or from other sources of scheduling information such as scheduling information derived from emails, SMS messages, social media messages, etc. The sensor data, location information, schedule data, etc. may be aggregated and used to determine the environment the host device is operating in.

Based on the determined operating environment, a noise profile can be generated. The noise profile can be used to apply gains to an audio signal. The noise profile may be determined based on the noise pattern of the environment the host device is determined to be in. In this regard, certain environments may have a noise pattern that is consistent. For example, an environment in a rural location may have a consistently quiet noise pattern whereas an environment in an urban location may have a consistently loud noise pattern. By applying the noise profile to the audio signal before forwarding the audio signal to the accessory for output, the user's listening experience may be improved.

According to some examples, the noise profile may, additionally or alternatively, be based on audio content received from the accessory. The received audio content may include external. audio and/or playback audio. Playback audio may be the audio content output and heard by the user. External audio may be the background audio, or noise.

The noise profile may include gains to improve the audio output of the accessory. For example, the gains may be for hearing assistance control (“HAC”), transparency control (“XPC”), and/or active noise control (“ANC”). The HAC gain may be applied to the audio signal to modify the way the audio output is being perceived by the user. The XPC gain may be applied to the audio signal allow the user to maintain a comfortable playback volume while still being able hear ambient sounds. The ANC gain may be applied to the audio signal to reduce or cancel most or all of the ambient or background noise. According to some examples, the noise profile may be applied to the audio signal before the audio signal is transmitted to the accessory for output.

For example, the operating environment of the host device may be an airplane. The host device may determine that the operating environment is an airplane based on aggregated sensor data, such as air pressure, the lack of location information due to the host device being in airplane mode, and schedule data indicating that the user is scheduled for a flight, etc.

The operating environment of the host may be continually monitored, and the noise profile updated as needed. For instance, the sensor data may include pressure data indicating a change in pressure during each stage of the flight. Each stage of the flight may have a consistent noise pattern. Thus, when the operating environment is determined to be a particular state of a flight, the host device may generate a noise profile based on the stage of the flight. The host device may then transmit the noise profile to an accessory. The accessory may then adjust its audio output in accordance with the noise profile.

The host device may be a smart phone, smart watch, tablet, laptop, etc. and the accessory may be a pair of earbuds, AR/VR headset, smart glasses, etc. The host device may be coupled to the accessory via a communications interface, such as Bluetooth, wi-fi, Universal Serial Bus, etc.

The host device may include sensors that can collect or determine information about the environment in which the host device is operating. According to some examples, the sensors may include pressure sensors, temperatures sensors, light sensors, humidity sensors, etc. The temperature sensors may determine the ambient air temperature and/or the device temperature. The light sensor may determine the illuminance, or amount of light received by the device. The pressure sensor may determine the ambient air pressure of the environment around the device. The humidity sensors may determine the ambient relative humidity of the environment.

The host device may determine location information. Location information may be the location of the environment in which the host device is operating and/or the location of the host device. The location information may be determined by location sensors and/or detected connectivity signals. For example, location sensors may include sensors capable of providing information regarding the host device's location, such as global positioning system (“GPS”) sensors. The host device may be able to detect connectivity signals and, based on the detected signals determine its location. For example, the host device may be able to determine location information based on signals, such as multicast DNS (“mDNS”) within a Wi-Fi network, Bluetooth low energy (“BLE”) broadcast from connected devices, and other location signals that can be aggregated to determine the location of the host device. For example, mDNS in a known WiFi network, BLE broadcast from accessories within a known location, as well as location signals may be combined to determine whether the host device is in a known location, such as the user's home, or a recognizable location, such as a public place.

The host device may be configured to operate in certain device states. Each device state may change the operation or capabilities of the host device. For example, the host device may include states such as airplane mode in which the location and/or communication sensors are disabled. In another example, the host device may have a do not disturb state in which no audible or haptic notifications are provided by the host device. In another example, the host device may include a vibrate mode in which the device vibrates to provide notifications or feedback.

The location information received from the location sensors and/or the detected connectivity signals may be aggregated to determine the location the host device is operating in. According to some examples, a fused location provider (“FLP”) may manage and/or aggregate the location information to determine the location the host device is operating in. For example, the FLP may automatically determine which of the one or more signals, such as location signals, WiFi mDNS, and/or BLE signals, to use in order to determine the location the host device is operating in. In some examples, the FLP may use the location signals, such as GPS, to determine the location the host device is operating in when the host device is operating in an outdoor location whereas the FLP may use the WiFi mDNS signals to determine the location the host device is operating in when the host device is operating in an indoor location. Additionally or alternatively, the FLP may predict the movement of the host device from one location to another based on sensor data. By predicting the movement of the host device, the FLP may manage the resources available to determine the location the host device is operating in in a battery efficient manner. For example, by predicting that the host device is moving from an outdoor location to an indoor location, the FLP may stop using location signals to determine the location the host device is operating in and, instead, use WiFi mDNS signals.

According to some examples, the location information may be aggregated with the data from any of the other sensors, such as the pressure sensors, temperature sensors, light sensors, humidity sensors, etc., along with information regarding the device state, schedule data, and/or whether the device is indoors or outdoors to identify an operating environment of the host device The location data may be aggregated and/or combined with data from other sensors, the device state, schedule data, and/or indoor and outdoor information using the FLP. For example, the FLP may automatically select one or more of the sensor data, device state, schedule data, indoor/outdoor location, and/or location data to use to determine an operating environment of the host device. According to some examples, the schedule data may be based on data entered into the calendar on the host device. For example, schedule data may include flight information, appointments indicating a certain address, etc. The device may determine whether it is indoors or outdoors based on Bluetooth and/or ultra-wide band (“UWB”) radio signals. For example, the signals, such as the Bluetooth or UWB signal, may have an angle of arrival and an angle of departure. The signals may, in some examples, include directional information. The angle of arrival, angle of departure, and/or directional information associated with the signals may be used to determine if the device is indoors or outdoors. According to some examples, the device may determine if it is indoors or outdoors based on the direction of travel at, near, and/or past a smart door lock. For example, the smart door lock may use geo-sensing to determine where the device is compared to a given location. According to some examples, if the door lock determines that the device is moving towards the door and/or is inside the door, the device may determine that the device is moving indoors and/or indoors. Additionally or alternatively, if the door lock determines that the device is moving away from the door and/or is on the outside of the door, the device may determine that it is moving outdoor and/or outdoors. Thus, based on whether the door lock locks or unlocks, the device may determine whether it is indoors or outdoors.

Based on the determined environment, the host device may generate a noise profile. According to some examples, the noise profile may be based on the determined environment as well as audio content received from the accessory. The noise profile may define gains to be applied to audio signals based on the noise pattern of the determined environment and/or the received audio content. The gains may include HAC, XPC, and ANC gains.

The host device may apply the gains defined by the noise profile to the audio signal before transmitting the audio signal to the accessory for output. In some examples, the host device may transmit the noise profile to the accessory. The accessory may then apply the gains defined by the noise profile to the audio signal before outputting the audio content. According to some examples, the accessory may generate the noise profile to be applied to the audio signal. In examples where the audio signal is output by the host device, the host device may apply the gains to the audio signal before outputting the audio content.

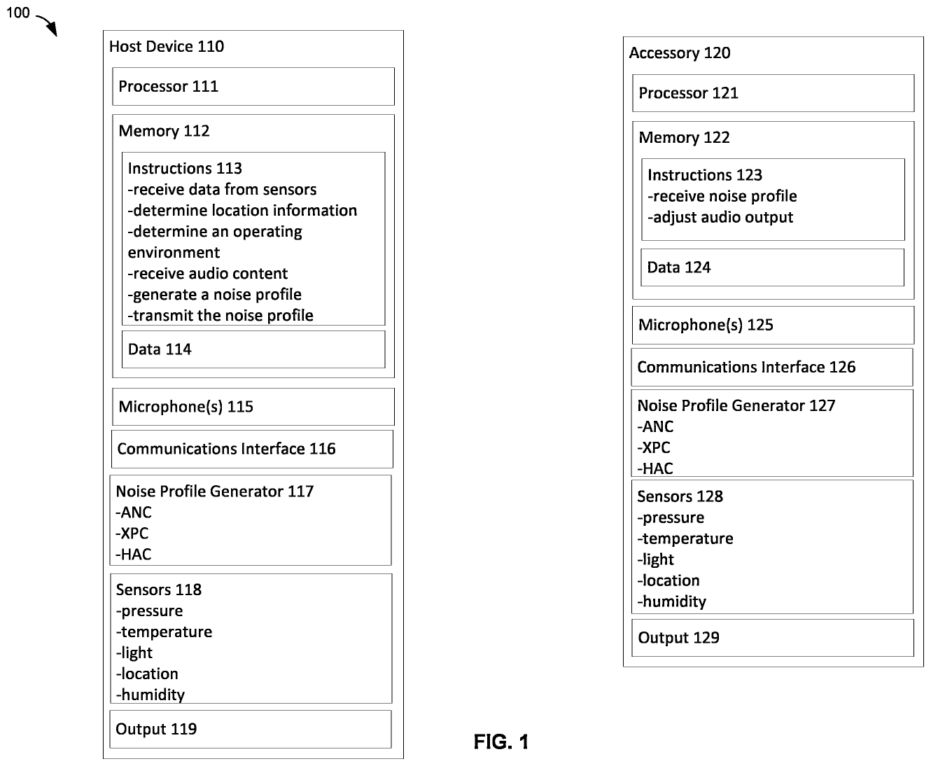

FIG. 1 illustrates an example system 100 in which the features described above and herein may be implemented. In this example, system 100 may include host device 110 and accessory 120. Host device 110 may contain one or more processors 111, memory 112, instructions 113, data 114, one or more microphones 115, a wireless communication interface or antenna 116, a noise profile generator 117, one or more sensors 118, and output 119.

The one or more processors 111 may be any conventional processors, such as commercially available microprocessors. Alternatively, the one or more processors may be a dedicated device such as an application specific integrated circuit (ASIC) or other hardware-based processor. Although FIG. 1B functionally illustrates the processor, memory, and other elements of host device 110 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of host device 110. Accordingly, references to a processor or computing device will be understood to include references to a collection of processors or computing devices or memories that may or may not operate in parallel.

Memory 112 may store information that is accessible by the processors, including instructions 113 that may be executed by the processors 111, and data 114. The memory 112 may be a type of memory operative to store information accessible by the processors 111, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 113 and data 114 are stored on different types of media.

Memory 112 may be retrieved, stored or modified by processors 111 in accordance with the instructions 113. For instance, although the present disclosure is not limited by a particular data structure, the data 114 may be stored in computer registers, in a relational database as a table having a plurality of different fields and records, XML documents, or flat files. The data 114 may also be formatted in a computer-readable format such as, but not limited to, binary values, ASCII or Unicode. By further way of example only, the data 114 may be stored as bitmaps comprised of pixels that are stored in compressed or uncompressed, or various image formats (e.g., JPEG), vector-based formats (e.g., SVG) or computer instructions for drawing graphics. Moreover, the data 114 may comprise information sufficient to identify the relevant information, such as numbers, descriptive text, proprietary codes, pointers, references to data stored in other memories (including other network locations) or information that is used by a function to calculate the relevant data.

The instructions 113 can be any set of instructions to be executed directly, such as machine code, or indirectly, such as scripts, by the processor 111. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The host device 110 may include one or more microphones 115. The microphones 115 may be able to receive audio input. The audio input may be processed by the noise profile generator 117.

In examples where the host device 110 is a wearable device, the microphones 115 of host device 110 may be located on a surface of the housing of host device 110 that is exposed when host device 110 is worn on the body. In some examples, the microphones 115 of host device 110 may be located on a surface of the housing of host device 110 that is in contact with the body when host device 110 is worn on the body.

The host device 110 may further include a wireless communication interface 116, such as an antenna, transceiver, and any other devices used for wireless communication. The antenna may be, for example, a short-range wireless network antenna. The host device 110 may be able to be coupled with accessory 120 via a wireless connection. For instance, the wireless communication interface 116 may be used to transmit and receive Bluetooth signals, WiFi signals or signals that use other short range wireless technologies.

According to some examples, host device 110 may receive content from accessory 120 over the wireless connection. The content may include audio signals picked up by microphones 125 on the accessory 120.

Host device 110 may transmit content to accessory 120 over the wireless connection. The content may be a noise profile that is generated by the noise profile generator 117. The noise profile may include gains to be applied to an audio signal output by the accessory 120. The content may also comprise music, speech or content from an audio source.

The host device 110 may include a noise profile generator 117. The noise profile generator 117 may create a noise profile based on the environment in which host device 110 is operating in. The noise profile may indicate frequency ranges in which a positive and/or negative gain may be applied to provide the user with gain adjusted sound, which may provide a better listening experience.

The noise profile generator 117 may receive input from sensors 118, schedule data, WiFi or BLE connectivity, device state, etc. The sensors 118 may include a pressure sensor, a temperature sensor, a light sensor, location sensors, humidity sensors, etc. The input received by the noise profile generator 117 may be aggregated to determine the environment in which the host device 110 is operating in. Based on the determined environment, the noise profile generator 117 may generate a noise profile that includes gains to improve the audio output of the host device 110 and/or accessory 120.

The noise profile generator 117 may create a noise profile using one or more adjustment modules. For example, the adjustment modules may include active noise control (“ANC”), transparency control (“XPC”), and/or hearing assistance control (“HAC”). These modules may comprise instructions that may be executed by processor 111 or may be implemented as integrated circuitry, e.g., an ASIC, a DSP residing on processor 111 or a portion of circuitry residing on processor 111.

The noise profile generator 117 may include an ANC module. The ANC module may modify the output of certain frequencies. For example, the ANC module may isolate the audio output from the ambient or background noises. Ambient or background noises may be traffic, weather related noises such as wind and thunder, indistinct background chatter, the sound of the air-conditioner or heater, etc. Isolating the audio output may include creating a noise opposite the ambient or background noise such that the ambient or background noise is cancelled or substantially decreased. According to some examples, ANC may digitally cancel low frequency audio.

The noise profile generator 117 and, therefore, the ANC module may receive audio input from the microphones. The audio input may be ambient noise, background noise, etc. A sound estimate may be determined based on the received audio. The sound estimate may include an intensity, frequency, etc. of the received audio. Based on the sound estimate, the noise profile generator 117 may determine a gain to be applied such that the audio output provides a natural perfection of the ambient sounds. In some examples, the ANC module may create anti-noise or anti-sound corresponding to the ambient or background noise received by the microphones. The anti-noise may have a sound wave, or frequency, opposite the undesired sound wave, or frequency, of the audio input. The anti-noise sound wave may cancel the sound wave of the audio input received by the microphones.

The noise profile generator 117 may include an XPC module. The XPC may allow the user to maintain a comfortable playback volume while still being able to hear ambient sounds. As described above and herein, the ANC module may reduce or cancel most or all of the background or ambient noise. To provide the user a more natural listening experience, the HAC module may modify or adapt the audio output using the XPC module to provide ambient noise as part of the audio output to the user. That is, while the ANC module may cancel the ambient noise, the XPC module may apply a gain to the received ambient noise such that the audio output is the same or similar to the user hearing the ambient noise without wearing the wearable device 110. The gain applied by the XPC module may be based on the determined environment. For example, the gain may be determined based on certain frequency ranges associated with a determined environment such that the user can hear the ambient noise as part of the audio output. In examples where host device 11 is a wearable device, this may provide the user a listening experience as if the user was not wearing the wearable device 110.

The noise profile generator 117 may include a HAC module. The HAC may apply a HAC gain to the audio input to modify the way the audio output is being perceived by the user. The HAC module may apply a positive gain to increase the intensity of certain frequencies or frequency ranges. For example, the audio gain profile may indicate that a user has hearing loss for a certain frequency range. The HAC module may apply a gain for audio within the identified frequency range. The amount of the gain may be based on the severity of hearing loss. By applying a positive gain, the intensity, or playback volume, may be increased. The inclusion of a HAC module may provide for a better user experience for users with mild to moderate hearing loss.

The host 110 may be capable of passive noise control (“PNC”) based on the materials used to manufacture the wearable device 110. In examples where the host device 110 and/or accessory 120 is a wearable device, the materials of the wearable device may block out ambient or outside noises from being received by the user. In examples where the wearable device is a pair of earbuds, the earpiece that fits within the user's ear may block or prevent sound from entering the ear. According to some examples, PNC may physically isolate high frequency audio input.

According to exome examples, the noise profile generator 117 may apply a least mean square algorithm to determine how to adjust the audio output using each adjustment module based on the environment the host device 110 is operating in. The LMS algorithm may use external microphone input and the processed output from the audiogram module to generate the desired filter gain response for the noise profile generator.

In some examples, the noise profile generator 117 may use a machine learning model to determine how to adjust the audio output using each adjustment module based on the determined environment. The machine learning model may be trained to determine the amount of gain to apply for each adjustment module. Each training example may consist of audio output provided to the user. The input features to the machine learning model may be audio information associated with the determined environment, volume commands received by the device to increase or decrease the playback volume, the ambient or background noise, etc. The machine learning model may use the input features to more accurately determine the amount of gain to be applied by each of the adjustment modules. The output of the machine learning model may be an amount of gain to be applied by each adjustment module of the noise profile generator 117. In some examples, the device may request feedback from the user. For example, the user may be asked whether the background noise was too loud or whether the audio output was too quiet. The user may provide feedback, such as a yes or no, indicating that the applied gains were appropriate for the user's listening preferences.

Host device 110 may further include an output 119. The output 119 may be, for example, a speaker.

Accessory 120 may each include one or more processors 121, memory 122, instructions 123, data 124, microphone(s) 125, wireless communication interface 126, noise profile generator 127, sensors 128, and output 129 that are substantially similar to those described herein with respect to host device 110. While the methods and examples described above and herein are being performed by host device 110, the methods and examples may be performed by the accessory.

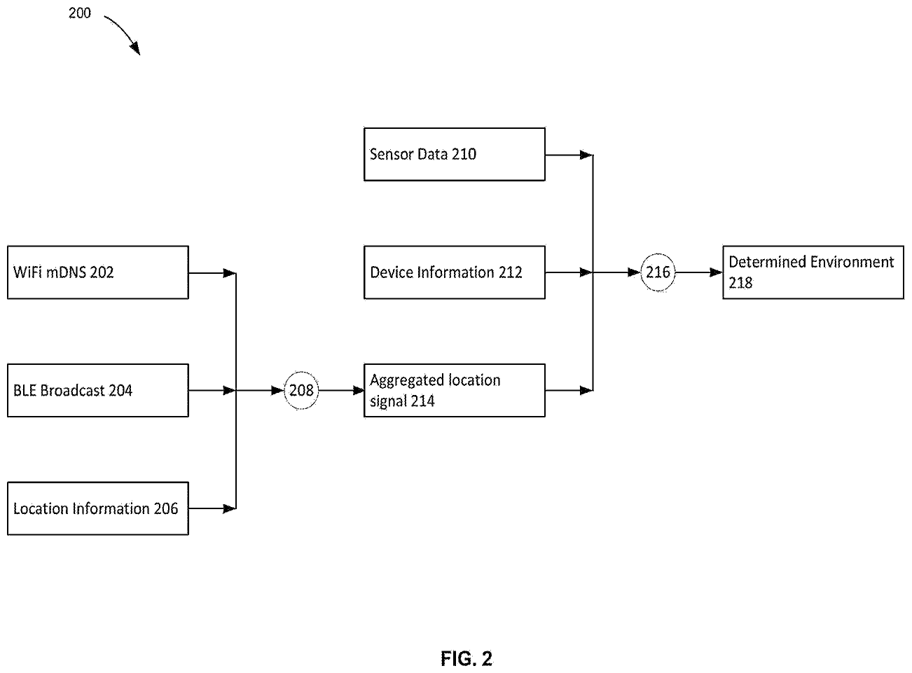

FIG. 2 illustrates an example method to determine the environment in which the host device 110 is operating in. As described above and herein, the noise profile generator 117 and/or the processors 111 of host device 110 may determine the environment the host device 110 is operating in. Connectivity information, such as WiFi mDNS 202, BLE broadcast 204, and location information 206 may be aggregated by a signal aggregator 208. The aggregated location signal 214 may then be aggregated with sensor data 210 and device information 212 by signal aggregator 216. The aggregate of sensor data 210, device information 212, and aggregated location signal 214 may be the determined environment 218.

Host device 110 may detect connectivity signals, such as WiFi mDNS 202 and BLE broadcast 204. The connectivity signals may be used to determine the location of the host device 110. For example, a mDNS in a known WiFi network or BLE broadcast from accessories within a known location may indicate that the host device 110 is in a known location, such as the user's home, or a recognizable public location, such as a coffee shop frequented by the user. Determining whether host device 110 is in a known location may provide a more accurate determination of the operating environment of the host device 110 as compared to when the host device 110 is in an unknown location.

The location sensors may determine location information 206 pertaining to the location of the environment in which the host device is operating and/or the location of the host device. The location sensors may include sensors capable of providing information regarding the location of the host device 110, such as GPS sensors.

The WiFi mDNS 202, BLE broadcast 204, and location information 206 may be aggregated by a signal aggregator 208. Signal aggregator 208 may combine or aggregate the WiFi mDNS 202, BLE broadcast 204, and location information 206 into aggregated location signal 214. The aggregated location signal 214 may be the determined location of host device 110. The aggregated location signal 214 may then be aggregated with sensor data 210 and device information 212.

Sensor data 210 may include data from the sensors 118. For example, the sensors 118 may include a pressure sensor, an ambient temperature sensor, a device temperature sensor, a light sensor, and/or a humidity sensor. The pressure sensor may measure the ambient air pressure of the environment the host device 110 is operating in. According to some examples, the pressure sensor may be a barometer. The ambient temperature sensor may measure the ambient temperature of the environment the host device 110 is operating in. The device temperature sensor may measure the temperature of the device as it is operating in a given environment. The light sensor may measure the illuminance or the amount of light received by the device in the environment the host device is operating in. The humidity sensor may measure the ambient relative humidity of the environment the host device 110 is operating in.

For example, if the host device 110 is operating at a beach location, it is likely that the pressure sensor would provide an increased reading, the ambient temperature would be increased, the device temperature is likely to be increased, the illuminance would be increased, and the humidity may be high or low, depending on the weather, as compared to when the host device 110 is operating at a ski resort on a mountain.

Device information 212 may include the device state, schedule data, whether the device is indoors or outdoors, etc. The device state may include, for example, off, airplane mode, do not disturb, silent, haptic mode, etc. For example, when host device 110 is off and/or in airplane mode, host device 110 may be unable to transmit or receive notifications, content, location information, etc. In some examples, when host device 210 is set to do not disturb, content received by host device 110 may not result in a notification or output provided to the user. When in silent mode, host device 110 may receive content and notifications but may only provide a visual notification. When in haptic mode, host device 110 may receive content and notifications but may only provide a haptic notification.

Schedule data may include information that has been entered into a calendar application that is associated with the user's account and, therefore the host device 110. For example, the host device 110 may include a calendar application associated with the user's account. Appointments, such as a doctor's appointment, or travel reservations may be used by the processors 111 to determine the environment in which the host device 110 is operating in. For example, if the schedule data includes information regarding a flight from New York City to San Francisco, the schedule data may be used to determine a location of the device and, therefore, the environment of the device based on the time of the flight.

The sensor data 210, device information 212, and aggregated location signal 214 may be aggregated by a signal aggregator 216. The signal aggregator 216 may output the determined environment 218. The determined environment 218 may be the environment in which the host device 110 is operating in. Based on the determined environment 218, the noise profile generator 117 may create a noise profile to be applied to audio output.

In examples where the audio signal is output by the accessory, the host device may transmit the noise profile to the accessory. The accessory may then apply the gains defined by the noise profile to the audio signal. In examples where the audio signal is output by the host device, the host device may apply the gains to the audio signal.

The method described above may be used to determine the environment in which an accessory 120 is operating in. According to some examples, the accessory 120 may use the above method to determine the environment in which the host device 110 and/or accessory 120 is operating using the method described above.

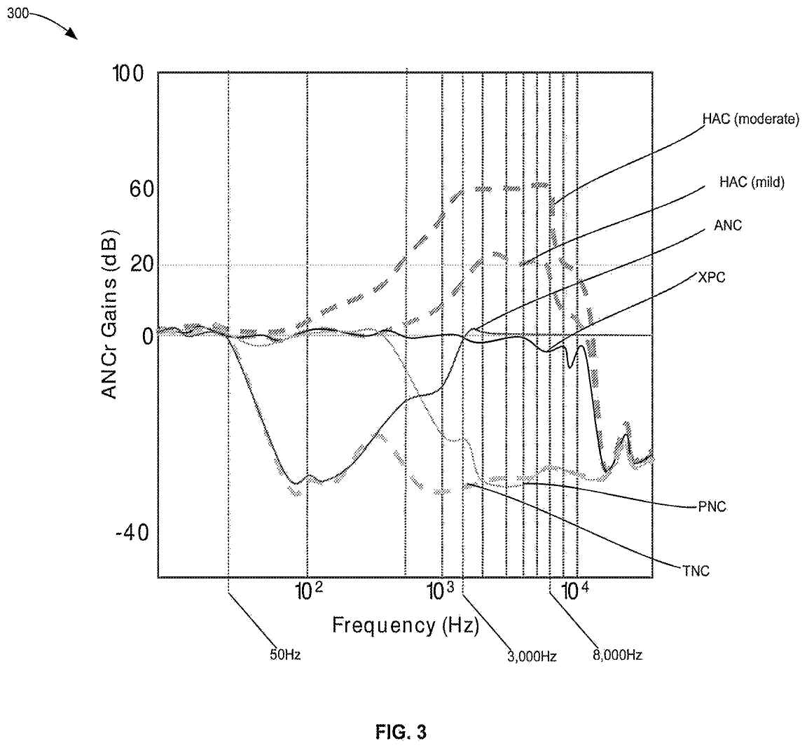

FIG. 3 illustrates a graphical representation of example audio gains for a generated noise profile. Graph 300 illustrates gains that may be applied to the audio output by the adjustment modules based on the noise profile. In some examples, the noise profile generator 117 may adjust the audio output based on parameters determined by a least mean square algorithm and/or the environment the host device 110 is operating in. For example, the least mean square algorithm may determine that the HAC module requires a larger gain in a certain frequency range than the ANC module in the same and/or different frequency range. The AHC block may apply positive and negative gains to certain frequency ranges using ANC, total noise cancellation (“TNC”), XPC, and HAC modules.

In the example shown in graph 300, the noise profile may indicate that the user has mild to moderate hearing loss for frequencies between approximately 3,000 Hz and 8,000 Hz. The noise profile may indicate that a positive gain may be applied by the HAC for frequencies between approximately 3,000 Hz and 8,000 Hz while a negative gain is applied by the ANC in other frequency ranges. This may allow for the user to better hear the audio output in the frequencies between 3,000 Hz and 8,000 Hz while blocking out other or unwanted audio in the frequencies outside of the 3,000 Hz to 8,000 Hz range.

As shown in graph 300, the ANC may apply a negative gain for frequencies between approximately 50 Hz and approximately 3,000 Hz. For example, as the frequency of the audio increases from approximately 50 Hz to approximately 100 Hz, the ANC may gradually apply an increasing negative gain to cancel audio at those given frequencies. For example, audio having a frequency of approximately 75 Hz may require a gain of −20 dB to cancel or negate the audio. Audio having a frequency of approximately 90 Hz may require a gain of approximately −30 dB to cancel or negate the audio at that frequency.

Between approximately 100 Hz and 3,000 Hz the negative gain applied by the ANC may gradually decrease. For example, as the audio frequency approaches 3,000 Hz, the gain applied by the ANC may decrease from approximately −30 dB to approximately 0 dB.

As shown in graph 300, as the gain applied by the ANC module approaches OdB at approximately 3,000 Hz, the HAC module may apply a maximum gain of approximately 20 dB in examples where the user has mild hearing loss and approximately 60 dB in examples where the user has moderate hearing loss. According to the example shown in graph 200, the HAC module may apply a positive gain for frequencies between approximately 3,000 Hz and 8,000 Hz, or the frequencies associated with the user's hearing loss. The amount of gain applied may depend on the severity of the hearing loss. The severity of the hearing loss may be provided as input to host device 110 by the user.

In examples where the host device 110 and/or accessory 120 is a wearable device, the PNC module may passively cancel noise due to the material and/or shape of the wearable device. In examples where the wearable device is a pair of earbuds, the portion of the earbud that is inserted into the user's ear may form a seal or a snug fit between the earbud and the user's ear. This may prevent outside or ambient noise from reaching the user's auditory system. The PNC module may work best at certain frequencies, based on the material of the wearable device. As shown, the PNC module may cancel or otherwise reduce audio signals at a frequency between approximately 1,000 Hz and above, although other frequencies and frequency ranges may be canceled or reduced by the PNC. According to some examples, the PNC module may be coming from the seal of the device when the device is powered off by the user.

The XPC module may apply a positive or negative gain to amplify or decrease the intensity of the ambient or background noise. This may allow the user to maintain a comfortable audio playback volume while still being able to hear ambient and/or background sounds. As shown in graph 200, the XPC module may not apply a positive or negative gain until the audio reaches a frequency of approximately 10,000 Hz. For example, the XPC module may not apply a gain to the audio received by the microphones such that the audio output by the XPC module is the same or similar to the audio output that the user would hear without wearing the wearable device.

According to some examples, the noise profile generator 117 may include a total noise cancellation (“TNC”) module. The TNC module may apply a negative gain across one or more frequency ranges. As shown in graph 200, the TNC module may apply a negative gain for frequencies greater than 50 Hz. The maximum negative gain applied by the TNC module may be in the frequency range associated with hearing loss. In this example, the maximum negative gain applied by the TNC module may be for audio having a frequency between 3,000 Hz and 10,000 Hz. According to some examples, the TNC module may be the combination of the PNC and ANC modules. For example, when the device switches to ANC mode, the noise cancellation benefit may be the total noise cancellation.

The noise profile generator 117 may create a noise profile to apply the gains determined by one more of the ANC, HAC, XPC, PNC, and TNC modules. The amount of gain applied by the noise profile may be based on the determined environment. In some examples, the amount of gain applied by the noise profile may also be based on a least mean square algorithm, as described above, and/or a machine learning model, also described above.

Environments may have a consistent pattern of sensor data, noise, device information, etc. that the host device 110 can use to determine the environment in which the host device 110 is operating in. For example, during an airplane flight there may be a pattern of pressure levels within the cabin, sound levels, light levels, temperature levels, etc. during each part of the flight. The parts of the flight may consist of boarding, take-off, ascent, cruise, descent, and deplaning.

A surrounding environment may include a noise pattern that is consistent. The consistent noise pattern, identifiable data readings, certain device states, scheduling data, etc. may be used to identify the environment surrounding the device. For example, when a user is on an airplane, each stage of the flight may have a consistent noise pattern. The stages of the flight may include boarding, take-up, ascent, cruising, descent, and deplaning. According to some examples, other sensor data, such as pressure sensor data, may be consistent for each stage of flight. In some examples, the device may receive schedule data, such as from a calendar, to identify that the user and, therefore the device, will be on an upcoming flight. The device state may also provide information that can be used to determine the environment surrounding the device. For example, when the device state is set to airplane mode, it is likely that the user and, therefore, the device are on an airplane. According to some examples, when the device state is set to airplane mode, the information from the one or more sensors combined with the airplane mode may be used to determine that the user and, therefore, the device are on an airplane. In some examples, the location information may be inferred based on the device being in airplane mode along with the sensor information, schedule data, etc.

During each stage of flight, the sensors may collect data. According to some examples, the device may receive information, such as external audio information, from the accessory. For example, the pressure determined by the pressure sensor may be approximately 100 kPa during boarding, between 100-80 kPA during ascent, approximately 80 kPA during cruise, between 80-97 kPa during descent, and approximately 97 kPa during deplaning. In some examples, the external audio may be approximately 70 dB during boarding, 85 dB during ascent, 83 dB during cruising, 86 during descent, and 82 during deplaning.

The device state may provide information regarding the stage of the flight. For example, the device state may be airplane mode during descent, cruise, and descent. During boarding and deplaning the device state may be do not disturb, silence, vibrate, volume on, etc.

The data from the sensors and the device state may be aggregated to determine the environment surrounding the device. In the case where the environment is determined to be an airplane, the device may further determine the stage of flight. Based on the determined surrounding environment, i.e. in an airplane, and the stage of flight, the device may generate a noise profile. The noise profile may define gains to be applied to audio output. The audio output may be output through the device or an accessory coupled to the device. In examples where the audio output is output through the accessory, the host device may transmit the noise profile to the accessory.

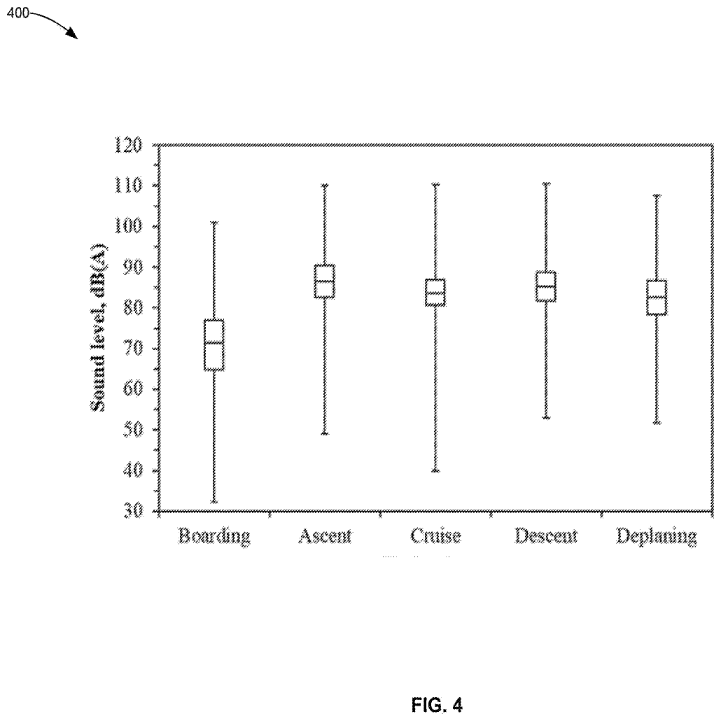

FIG. 4 illustrates an example noise pattern for an airplane flight. As shown in graph 400, which illustrates the sound level in dBA for each part of the flight, boarding, ascent, cruise, descent, and deplaning each have an average range of sound levels. The sound sensor may measure, or determine, the sound level of the environment during each part of the flight. Based on the determined sound level, the host device may determine which part of the flight the host device is operating in.

For example, during boarding, the average sound level on the airplane may be 72 dBA but have a range between 65-77 dBA. During ascent, the average sound level on the airplane may be 87 dBA, but have a range between 83-90 dBA. When at cruising altitude, the average sound level on the airplane may be 84 dBA, but have a range between 81-87 dBA. During descent, the average sound level may be 85 dBA, but have a range between 82-85 dBA. When deplaning, the average sound level may be 85 dBA, but have a range between 78-86 dBA. The average sound levels and ranges provided herein are merely examples and, depending on the flight or environment, may be more or less. Therefore, the averages and ranges provided herein are not intended to be limiting.

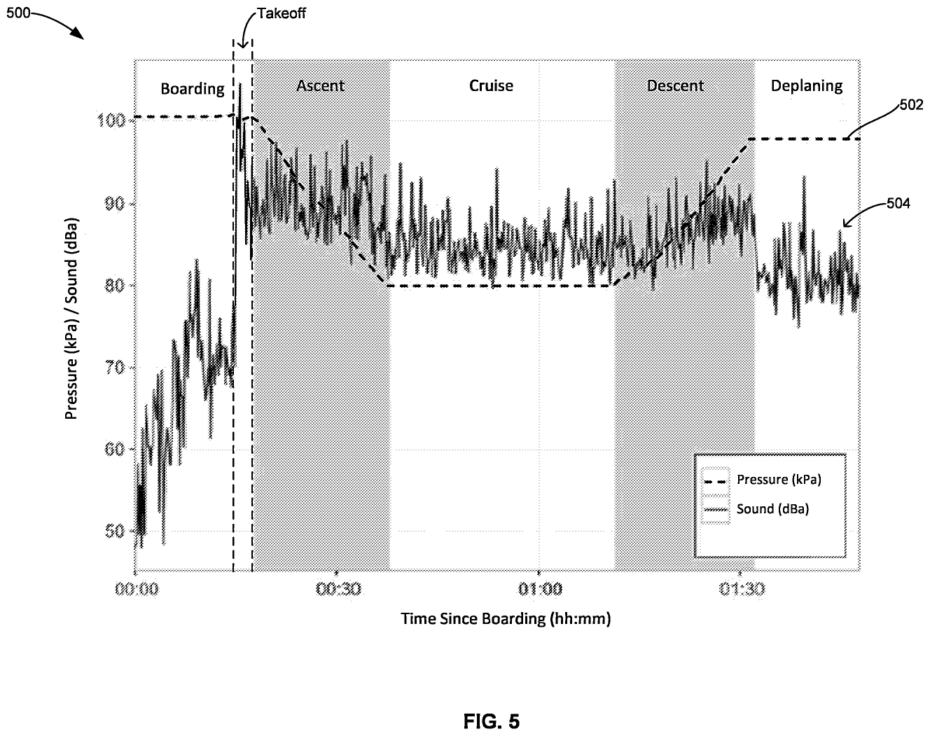

Additionally or alternatively, the host device may determine the stage of the flight based on data from the pressure sensor. FIG. 5 illustrates the relationship between pressure levels and sound levels during a time. Graph 500 illustrates the pressure level 502 in kPa and the sound level 504 in dBA for each stage of the flight.

For example, when the airplane is on the ground for boarding, the pressure level 502 remains constant at approximately 101 kPA. The sound level 504 during boarding may range from approximately 47 dBA, when passengers just begin to board the plane, to 83 dBA, when all the passengers have boarded the plane. The sound level 504 may decrease prior to take. For example, passengers may have to quiet down to hear the announcements and/or watch the safety video, thereby decreasing the sound level.

During take-off the sound level 504 may increase to its highest levels. The increase may be due to external noise, such as the engine, or noise within the cabin, such as passengers talking. The pressure level 502 within the airplane cabin may remain substantially the same as the pressure level during boarding.

During ascent, the sound level 504 may be greater than the sound level during boarding but less than the sound level during take-off. The sound level 504 during ascent may be between 85-97 dBA. The pressure level 502 within the cabin may decrease during ascent. The pressure level 502 may decrease as the altitude of the airplane increases. For example, the pressure level 502 may decrease from approximately 101 kPA to 79 kPA.

Once the airplane reaches cruising altitude, the pressure level 502 within the cabin may stabilize. The pressure level during the cruising stage may be approximately 79 kPA. The sound level 504 may, additionally or alternatively, stabilize during the cruising stage. For example, the sound level 504 during the cruising stage may range from 79-93 dBA. There may be some times during the cruising stage where the sound level 504 is greater than the average range. For example, during service, clean up, etc. the sound level 504 may increase due to discussions between the passengers and the stewards. Additionally or alternatively, there may be times during the cruising stage where the sound level is less than the average range. For example, if the flight is a redeye, or overnight flight, an early morning flight, a late night flight, etc., the sound level 504 may decrease as many passengers may be sleeping.

During descent, the sound level 504 may be substantially the same or slightly greater than the sound level during the cruising stage. For example, the sound level 504 may increase during the descent as people start cleaning and/or packing up their belonging in preparation for landing. In some examples, the sound level 504 may increase due to the increase in engine and/or braking noise as the airplane prepares for landing. When the airplane is descending in height, the pressure level 502 within the cabin may increase. For example, the pressure level 502 within the cabin may gradually increase from 79 kPA to 97 kPA as the altitude of the airplane decreases.

While deplaning, the pressure level 502 may remain consistent. For example, the pressure level 502 may remain substantially constant at 97 kPA. The sound level 504 while deplaning may range from 75-85 dBA. The sound level 504 during deplaning may fluctuate due to the number of passengers on the plane, the amount of vehicles on the tarmac around the plane, etc.

Host device 110 may measure or determine the sound level or pressure level during the flight. The host device 110 may compare the determined sound level to determine the pressure level as a way to provide a high level of confidence in determining the stage of the flight. For example, if the sound sensor measures a sound level of approximately 75 dBA, the airplane may be the ascent, cruise, or descent stage of the flight. However, if the pressure sensor measures a pressure level of approximately 80 kPa at the same time the sound level is approximately 75 dBA, the host device 110 may determine that the airplane is in the cruising stage.

Host device 110 may additionally or alternatively measure data from other sensors. For example, the host device 110 may measure the illuminance within the cabin of the airplane. The host device 110 may receive or register more light during boarding and deplaning as compared to when the airplane is in the cruising stage, when the lights within the cabin are often turned down. According to some examples, the host device may measure the ambient temperature within the cabin of the airplane. The ambient temperature may be greater during boarding and deplaning as compared to the cruising stage. The host device may aggregate any combination of sensor data to determine the stage of the flight.

According to some examples, the sensor data may be aggregated with device information and/or location signals. The device information may include schedule data, the device state, etc. The schedule data may provide a way to check or confirm that the user and, therefore, the host device is scheduled to be on a flight at that time. During boarding, the device state may be any device state, such as off, do not disturb, haptic, sounds on, etc. However, during the flight, including take-off, ascent, cruising, and descent, the device state may be on airplane mode. Thus, the host device may not receive location information or connectivity signals. The device state of airplane mode may provide another confirmation that the host device is on a flight.

After the sensor data, device information, and any location signals are aggregated, the host device may determine the environment in which it is operating. The determined environment in the case of an airplane flight may be the stage of the flight, such as take-off, ascent, cruising, descent, etc. Based on the determined environment and, in this example, the stage of flight, the host device may generate a noise profile. The noise profile may define gains to be applied to the audio signal. In examples where the audio signal is output by the host device, the host device may apply the gains to the audio signal before outputting the audio signal. In examples where the audio signal is output by an accessory, the host device may transmit the noise profile to the accessory. The accessory may then apply the gains to the audio signal.

While the above example describes the host device determining that it is operating within an airplane, the host device may determine it is operating in any number of environments. For example, the host device may determine the environment is a different mode of transportation, such as a train, bus, or car. In some examples, the host device may determine the environment is a public place, a rural, suburban, or urban environment, etc.

For example, a train or bus may have a consistent noise pattern during each stage of the ride. The stages of the ride may include leaving the station, traveling between stations, and reaching a destination station. Each stage may have an average range for each of the sensors that is consistent for a given stage of the train or bus ride. For example, each stage of the train or bus ride may have an average sound level, illuminance, temperature, pressure, etc. range. The host device may compare the measured sound level, illuminance, temperature, pressure, etc. data to average ranges for train and bus rides to determine the environment the host device is operating in and/or the stage of the train or bus ride. In some examples, the host device may receive location signals that are changing at a speed corresponding to the speed of the bus or train. The host device may use the changing of location signals and/or the speed at which the host device is traveling to determine the environment in which it is operating in. According to some examples, the sensor data may, additionally or alternatively, be aggregated with device information and location signals to determine which stage of the train or bus ride the host device is operating in. Based on the determined environment and/or stage of the ride, the noise profile generator may generate a noise profile.

A method similar to those described above with respect to the environment being an airplane, train, or bus may be used to determine that the environment is a car. For example, the host device may measure a sound level consistent with average sound levels of road noise associated with driving a car. The host device may, additionally or alternatively, receive data from other sensors and/or location signals. For example, the location signals may be changing or indicate that the host device is traveling at a certain speed. The host device may determine that the host device is within a car due to the determined speed. According to some examples, the host device may determine that the host device is operating in a car based on the aggregation of sensor data, device information, and/or location signals. After the host device determines that the host device is operating in a car, the noise profile generator may generate a noise profile to apply gains to the audio signal to enhance the user's listening experience in the car. According to some examples, the car may be the accessory the host device is coupled to. In such an example, the generated noise profile may be transmitted to the car. The car may apply the gains to the audio signal before outputting the audio signal.

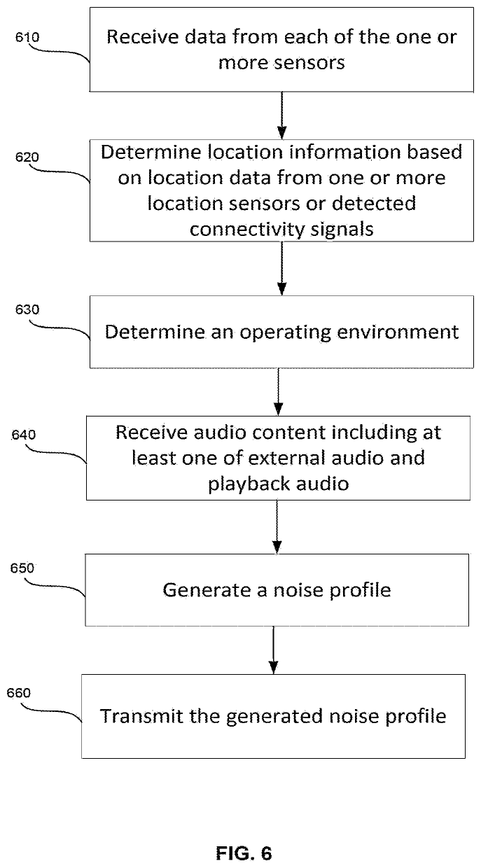

FIG. 6 illustrates an example method of generating and transmitting a noise profile based on the environment in which a host device is operating in. The following operations do not have to be performed in the precise order described below. Rather, various operations can be handled in a different order or simultaneously, and operations may be added or omitted.

For example, in block 610, the host device may receive data from each of the sensors. The sensors may include a pressure sensor, temperature sensor, light sensor, humidity sensor, location sensor, etc. Each of the sensors may measure or determine information about the environment in which the host device is operating in.

In block 620, the host device may determine location information based on location data from cation sensors or detected connectivity signals. The location sensor may be, for example, a GPS sensor. The connectivity signals may be mDNS and/or BLE broadcast. The host device may determine it is operating in a known location based on mDNS in a known WiFi network or BLE broadcast from a known accessory. According to some examples, the host device may determine its location based on the GPS sensor data.

In block 630, the host device may determine its operating environment. For example, the location information from the GPS sensor may be aggregated with the connectivity signals to form an aggregated location signal. The aggregated location signal may be aggregated with the sensor data. According to some examples, the aggregated location signal and sensor data may, additionally or alternatively, be aggregated with device information. Device information may include schedule data, device state information, etc. The operating environment may be determined based on the aggregation of the aggregated location signal, sensor data, and/or device information.

In block 640, the host device may receive audio content including at least one of external audio and playback audio. The audio content may be ambient noise, background noise, etc. A sound estimate may be determined based on the received audio content. The sound estimate may include an intensity, frequency, etc. of the received audio content.

In block 650 the noise profile generator may generate a noise profile including gains to be applied to the audio signal to be output to the user. The noise profile may be based on the determined operating environment and/or the sound estimate. The gains may be applied such that the audio output provides a natural perfection of the ambient sounds. The noise profile generator may include an ANC, XPC, HAC, PNC, and/or TNC module.

In block 660, the host device may transmit the generated noise profile to the connected accessory. The accessory may adjust the output of the audio signal by applying the gains defined in the noise profile.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A host device, comprising:
one or more sensors;
one or more processors in communication with the one or more sensors, the one or more processors configured to:
receive data from each of the one or more sensors;
determine location information based on location data from one or more location sensors or detected connectivity signals;
determine, based on the received data and the location information, an operating environment of the host device;
receive, from an accessory, audio content including at least one of external audio and playback audio;
generate, based on the determined operating environment and the received audio content, a noise profile; and
transmit, to the accessory, the generated noise profile.

2. The host device of claim 1, wherein the one or more sensors includes a pressure sensor, a temperature sensor, a light sensor, a location sensor, a presence sensor, and a humidity sensor.

3. The host device of claim 1, wherein the received data from the one or more sensors includes at least one of an air pressure of the operating environment, an ambient air temperature, a device temperature, an illuminance, and an ambient relative humidity of the operating environment.

4. The host device of claim 1, wherein the generated noise profile includes one or more gains to be applied to output audio.

5. The host device of claim 4, wherein the one or more gains includes at least one of hearing assistance control (“HAC”), transparency control (“XPC”), active noise control (“ANC”), total noise cancellation (“TNC”), or passive noise control (“PNC”).

6. The host device of claim 1, wherein the determined operating environment includes a noise pattern.

7. The host device of claim 1, further comprising a communications interface, wherein the host device is wirelessly coupled to the accessory via the communications interface.

8. The host device of claim 1, wherein the detected connectivity signals is at least one of a multicast DNS within a Wi-Fi network or a Bluetooth broadcast.

9. A method, comprising:
receiving, from each of one or more sensors, data;
determining, by one or more processors based on location data from one or more location sensors or detected connectivity signals, location information;
determining, by the one or more processors based on the received data and location information, an operating environment of the host device;
receiving, by the one or more processors from an accessory, audio content including at least one of external audio and playback audio;
generating, by the one or more processors based on the determined operating environment and the received audio content, a noise profile; and
transmitting, by the one or more processors to the accessory, the generated noise profile.

10. The method of claim 9, wherein the one or more sensors includes a pressure sensor, a temperature sensor, a light sensor, a location sensor, a presence sensor, and a humidity sensor.

11. The method of claim 9, wherein the received data from the one or more sensors includes at least one of an air pressure of the operating environment, an ambient air temperature, a device temperature, an illuminance, and an ambient relative humidity of the operating environment.

12. The method of claim 9, wherein the generated noise profile includes one or more gains to be applied to output audio.

13. The method of claim 12, wherein the one or more gains includes at least one of hearing assistance control (“HAC”), transparency control (“XPC”), active noise control (“ANC”), total noise cancellation (“TNC”), or passive noise control (“PNC”).

14. The method of claim 9, wherein the determined operating environment includes a noise pattern.

15. The method of claim 9, wherein the detected connectivity signals is at least one or a multicast DNS within a Wi-Fi network or a Bluetooth broadcast.

16. A non-transitory computer-readable medium storing instructions, which when executed by one or more processors, cause the one or more processors to:
receive data from each of one or more sensors;
determine location information based on location data from one or more location sensors or detected connectivity signals;
determine, based on the received data and location information, an operating environment of the host device;
receive, from an accessory, audio content including at least one of external audio and playback audio;
generate, based on the determined operating environment and the received audio content, a noise profile; and
transmit, to the accessory, the generated noise profile.

17. The non-transitory computer-readable medium of claim 16, wherein the one or more sensors includes a pressure sensor, a temperature sensor, a light sensor, a location sensor, a presence sensor, and a humidity sensor.

18. The non-transitory computer-readable medium of claim 16, wherein the received data from the one or more sensors includes at least one of an air pressure of the environment, an ambient air temperature, a device temperature, an illuminance, and an ambient relative humidity of the environment.

19. The non-transitory computer-readable medium of claim 16, wherein the generated noise profile includes one or more gains to be applied to output audio.

20. The non-transitory computer-readable medium of claim 19, wherein the one or more gains includes at least one of hearing assistance control (“HAC”), transparency control (“XPC”), active noise control (“ANC”), total noise cancellation (“TNC”), or passive noise control (“PNC”).
